(19) United States
(12) Patent Application Publication
(10) Pub. No.: US 2025/0131323 A1
(43) Pub. Date: Apr. 24, 2025

(54) DATA SHIFT-RESILIENT UNIT TESTING OF VERY LARGE MODELS

(71) Applicant: Dell Products L.P., Round Rock, TX (US)

(72) Inventors: Paulo Abelha Ferreira, Rio de Janeiro (BR); Vinicius Michel Gottin, Rio de Janeiro (BR); Pablo Nascimento da Silva, Niterói (BR)

(21) Appl. No.: 18/490,999

(22) Filed: Oct. 20, 2023

(51) Int. Cl. G06N 20/00

(52) U.S. Cl. CPC G06N 20/00

(57) ABSTRACT

One example method includes generating a first test metric using an unknown dataset and second test metrics using shifted datasets that are shifted versions of a known dataset. A data distribution difference is determined between the unknown dataset and one of the shifted datasets that is closest to the unknown dataset. A determination is made if the data distribution difference is less than or equal to a first known threshold, and applying the data distribution difference to a correlation model to determine an estimated test metric difference. A test metric difference id determined between the first test metric and a second test metric associated with the one of the shifted datasets that is closest to the unknown dataset. A determination is made if a difference between the test metric difference and the estimated test metric difference is less than or equal to a second known threshold.

Embodiments of the present invention generally relate to machine learning models and to testing machine learning models, including very large machine learning models. More particularly, at least some embodiments of the invention relate to systems, hardware, software, computer-readable media, and methods for testing very large machine learning models.

### BACKGROUND

Machine learning models are examples of applications that become more accurate in generating predictions without being specifically programmed to generate the predictions. There are different manners in which machine learning models learn. Examples of learning include supervised learning, unsupervised learning, semi-supervised learning, and reinforcement learning.

Generally, a machine learning model is trained with certain types of data. The data may depend on the application. Once trained or once the machine learning model has learned from the training data, the machine learning model is prepared to generate predictions using real data.

Training a machine learning model, however, can be costly. This is particularly true for certain machine learning models such as VLMs (Very Large Models). VLMs may have, for example, on the order of a trillion parameters. As a result, training and testing VLMs can be costly from both economic and time perspectives.

These VLM training and testing difficulties can present problems whenever a change is made to anything associated with the operation of the VLM. If a change is made to the dataset, the model pipeline, or the codebase, there is a need to ensure that the VLM remains valid. In fact, there are many instances where it is critical to have quality and performance guarantees, such as in self-driving vehicles. Accordingly, example embodiments disclosed herein address issues associated with retraining and retesting VLMs while minimizing costs and ensuring that changes surrounding the VLMs do not adversely impact the behavior of the VLMs.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of automatic or semi-automatic unit testing of very large machine learning models according to an embodiment;

FIG. 2 discloses aspects of testing very large machine learning models according to an embodiment;

FIGS. 3A-3D disclose aspects of training and testing very large machine learning models during an offline stage according to an embodiment;

FIGS. 4A and 4B illustrate aspects of testing a known dataset and an unknown dataset using very large machine learning models according to an embodiment;

FIGS. 5A-5C disclose aspects of training and testing very large machine learning models during an online stage according to an embodiment;

FIG. 6 discloses a method according to an embodiment; and

FIG. 7 discloses an example computing entity configured to perform any of the disclosed methods, processes, and operations.

### DETAILED DESCRIPTION OF SOME EXAMPLE EMBODIMENTS

Embodiments of the present invention generally relate to machine learning models including very large machine learning models (VLMs), referred to generally herein as models. More particularly, at least some embodiments of the invention relate to systems, hardware, software, computer-readable media, and methods for unit testing of very large machine learning models.

Model management relates to managing models and ensures that the models meet expectations and business requirements. Model management also ensures that models are properly stored, retrieved, delivered in an up-to-date state, and the like. Embodiments of the invention relate to increasing quality assurance when a change or changes are made to a model pipeline, model datasets, model codebase, or the like. Embodiments of the invention are able to retrain and/or retest a model while reducing or minimizing costs.

Retraining and/or retesting models such as VLMs can be cost prohibitive and embodiments of the invention ensure that, when a change that may impact the behavior of a model occurs, the training and validation behavior remains the same or sufficiently close to the expected behaviors of the model prior to the change. In order to retrain and/or retest in a more cost-effective manner, embodiments of the invention may generate a small or proxy version of a model using compression, such as neural network compression. Embodiments of the invention may perform unit testing on compressed models.

A framework is provided that allows specific tests to be created for a given functionality of a model such as a VLM. For example, a test for the expected final training error or the expected validation error curve may be created. These tests are executed using the proxy or compressed versions of the models. Embodiments of the invention relate to unit testing and neural network compression in a single framework.

Aspects (e.g., functionality, behavior, metrics) of models can be tested using unit tests. A unit test, which may be automated, helps ensure that a particular unit of code or other aspect of a model is performing the desired behavior. The unit of code being tested may be a small module of code or relate to a single function or procedure. In some examples, unit tests may be written in advance.

Model compression allows a compact version of a model to be generated. Compression is often achieved by decreasing the resolution of a model's weights or by pruning parameters. Embodiments of the invention ensure that the compressed model is small and achieves similar performance on selected metrics with respect to the original uncompressed model. The compressed models may be, by way of example only, 10%-20% of the size of the original models while still achieving comparable metrics.

A framework is further provided for determining if the passing or failing of a unit test is based on an underlying problem with the data pipeline or if the passing and failing is based on changes to the underlying distribution of the data used to train or execute the models. That is, if a change in the distribution (i.e., data drift) exists in the domain, the unit tests with the compressed models may fail in cases in which the VLM still retains total (or sufficient) functionality. Thus, the framework disclosed herein accounts for changes in the data distribution between the time at which the VLM (and the compressed test model) are trained and the time at which the test (with the compressed model) takes place. This helps to ensure that the training and validation behavior of these models remain close to the expected one, which helps to avoid costly retraining or revalidating them every time a change is made to codebase or data.

One example method includes generating a first test metric using an unknown dataset and second test metrics using shifted datasets that are shifted versions of a known dataset. A determination is made of a data distribution difference between the unknown dataset and one of the shifted datasets that is closest to the unknown dataset. A determination is made if the data distribution difference is less than or equal to a first known threshold, and in response, applying the data distribution difference to a correlation model to determine an estimated test metric difference. A determination is made of a test metric difference between the first test metric and a second test metric associated with the one of the shifted datasets that is closest to the unknown dataset. A determination is made if a difference between the test metric difference and the estimated test metric difference is less than or equal to a second known threshold.

### A. Aspects of Testing VLMs

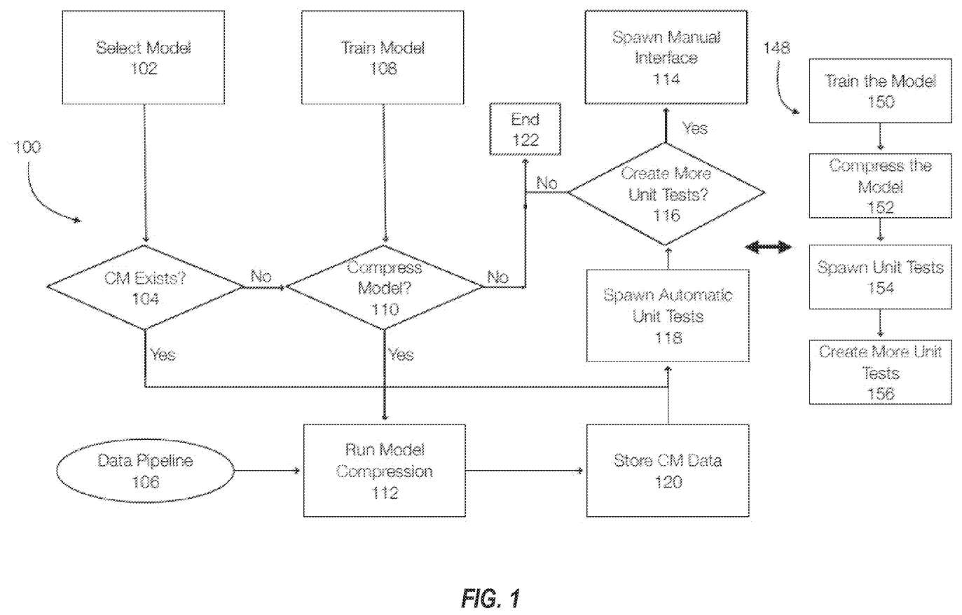

FIG. 1 discloses aspects of a framework for managing models. FIG. 1 presents a method 100 performed in a framework that allows models to be tested more effectively. The framework generally executes unit tests on compressed models (CMs), which are generated by compressing the corresponding models. The CMs are examples of proxy versions of the original VLMs. Embodiments of the invention are capable of testing multiple models independently and simultaneously using corresponding compressed models.

The method 100 may begin in different manners. For example, the method 100 may begin by selecting 102 a model that has already been trained. If a compressed model (CM) for the selected model exists (Yes at 104), the method may spawn 118 automatic unit tests. Spawning tests 118 may include recommending tests for execution. These tests may have been developed in advance and may be automatically associated with the CM.

If the CM does not exist (No at 104), the model may be compressed 110. If the model is not compressed, the method ends 122. If a compressed model is generated (Yes at 110), the compressed model is run or executed 112 using a data pipeline 106. Metadata generated from running the compressed model is stored 120 and unit tests may be created or spawned 118.

Another starting point is to train 108 a model and then compress (Yes at 110) the model. If the model is not compressed, (No at 110), the method may end 122. If there is a need to compress 110 the model that has been trained 108 (Yes at 110), a compression model is run 112 based on data from a data pipeline 106. The output of the compression model is stored 120 as CM metadata and automatic unit tests are spawned 118.

Training 108 a model, particularly a very large model, may require access to large amounts of storage and multiple processors or accelerators. Training the model may require days or weeks, depending on the resources. Because of the time required to train the model or for other reasons, embodiments of the invention may store metadata associated with training the model. The metadata generated and/or stored may include, but is not limited to, training/validation loss evolution, edge cases with bad prediction, timestamps for waypoints along training/validation, or the like. These metadata can be used for various automatic unit tests. More specifically, the unit test may generate or be associated with metadata that can be compared to the metadata generated during training or collected for validation of the model.

As previously stated, compressing a model into a CM is performed and metadata associated with training and validating the CM are stored. Embodiments of the invention do not require the CM to achieve the same level of accuracy or other metric as the original model. Rather, the CM serves as a valid proxy when the metric or other output is reasonable. Reasonable may be defined by a threshold value or percentage. Further the assessment of the metric or output can be based on hard (exact) or soft (withing a threshold deviation) standards.

Embodiments of the invention may rely on the relationship between the metadata gathered or generated by the CM and the metadata gathered or generated by the original model. When running a unit test, the current training or validation data or metrics (metadata) generated by the running or executing the CM with the change may be compared to the metadata stored in association with the model prior to the change.

Regardless of the starting point of the method 100 (selecting 102 or training 108 a model), once a CM is associated with a model and metadata for the CM has been generated, a series of automatic unit tests can be created or spawned 118. These unit tests may assert a hard or soft comparison between the metadata of the stored CM with the metadata of the CM based on the modified code base.

In addition, embodiments of the invention allow a user to create 116 additional unit tests, for example via a manual interface 114. These unit tests can be based on any metadata related to the CMs and may be created to address cases or situations that are not covered by the automatically generated unit tests.

In general, the method 100 may be represented more compactly by the method 148 performed in the framework of method 100. The method 148 may include training/selecting 150 a model. The trained/selected model is compressed 152 to generate a compressed model. In one example, the trained/selected model may already be associated with a compressed model and the compressed model does not need to be generated. Unit tests can be created or spawned 154 for the compressed model. Additional unit tests can be created 156 for the compressed model.

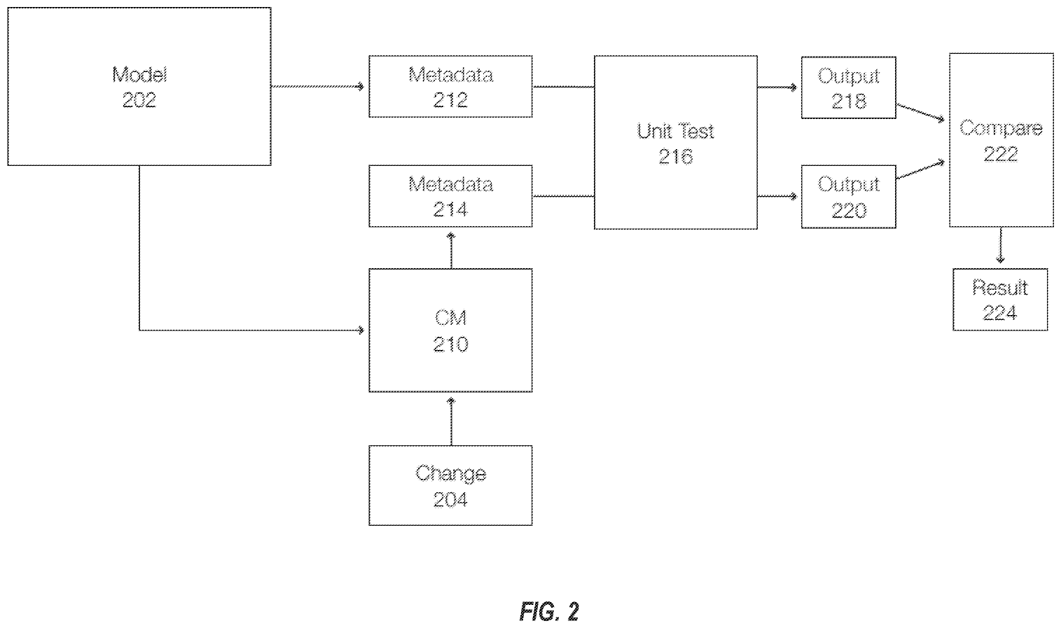

FIG. 2 discloses aspects of unit tests and unit testing. Unit tests can vary widely in function and purpose and the following discussion provides a few examples. Embodiments of the invention are not limited to these examples. FIG. 2 illustrates a model 202. The CM 210 is generated by compressing model 202. Metadata 212 is generated from operation and/or training of the model 202.

Whenever there is a change that impacts the model 202, it may be necessary to determine whether the behavior or other aspect of the model 202 is affected. In this example, the model 202 is impacted by or associated with a change 204. The change 204 may be a change to the training data or other data set, the codebase of or used by the model 202, the pipeline or the like. The metadata 214 is generated from operation of the CM 210.

The unit test 216 can be performed separately or independently on the metadata 212 and the metadata 214. Thus, the unit test 216 generates an output 218 from the metadata 212 and the unit test 216 generates an output 220 from the metadata 214. The output 218 and 220 are compared 222 to generate a result 224. The result 224 may indicate whether the model 202 is operating as expected or whether any change in behavior is acceptable in light of the change 204. Stated differently, the result 224 may indicate that the behavior, prediction, or other aspect of the model 202 is operating properly or valid for the aspect of the model 202 tested by the unit test 216.

As illustrated in FIG. 2, the impact of the change 204 on the model 202 is evaluated by generating the metadata 214 using the CM 210 in the context of the change 204. In other words, the CM 210 run, and the metadata 214 reflects the change 204, which may be to the training data or other data set, codebase, or model pipeline.

Embodiments of the invention allow the behavior of the model 202 to be evaluated based on unit tests that are applied to the CM 210. More specifically, the behavior of the model 202 can be compared to the behavior of the CM 210. The behavior of the CM 210, which is operated in the context of the change 204, allows the impact of the change 204 on the model 202 to be determined and to determine whether the behavior of the model 202 will be acceptable in light of the change 204.

As previously stated, unit tests may be generated automatically. Once a CM is generated, unit tests can be automatically associated with the CM. This is one way to identify which unit tests should be performed in the event of the change 204. Further, unit tests can be suggested (e.g., based on actions of other users or based on unit tests for similar models) to the user. Unit tests may also be created.

Unit tests can be created to test different functions, metrics, or other aspects of models and may be specific to changes or to the type of the change. Thus, changes impacting the codebase may be performed with specific metadata or metrics related to the part of the codebase that was changed. Unit testing is often used in test-driven machine learning development. This allows tests to be written in order to detect changes to intended behavior. This allows for development to be performed rapidly.

In the context of very large machine models, automatic unit testing using CMs overcomes the problem of having to test the actual model. Unit tests can be generated based on generic algorithms, based on feedback, or the like.

For example, the unit test 216 may be an inner model metric unit test. In this case, the unit test attempts to measure deviation from established inner model metrics. For a given dataset (or portion thereof), for example, a certain final state or behavior may be expected. The metric can involve a single hidden layer, two or more hidden layers, interactions between those layers, or the like.

When the output 220 (for the CM 210 with the change 204) is sufficiently close or equal to the output 218 (for the model 202 without the change), then the test may be a success. More specifically, the unit test is performed on metadata 214 generated by the CM 210 rather than the model 202 itself because, as previously stated, testing very large machine models takes substantial time and/or cost. Thus, the output 220 is associated with the CM 210 and gives an indication of how the change 204 impacted the original model 202.

If the deviation (e.g., difference between the output 220 and the output 218) is sufficiently small or within a threshold (e.g., 1%, 2%, 3%, 4%, 5%, 6%, 7%, 8%, 9%, 10%, or other value), the test may be a success. In this example, the metadata associated with an inner model metric unit test may include values pertaining to hidden layers of the model/CMs in relation to a given dataset or portion thereof. These metadata serve to assert the expected behavior of the model with respect to a given set of input samples and allow the functionality of the model 202 to be tested using the CM 210 that is operated in the context of the change 204.

In another example, the unit test 216 may be an output metric unit test. Output metric unit tests are configured to compare the output 218 (e.g., a prediction or inference) associated with the model 202 with the output 220 associated with the CM 210. The output metric unit test is thus configured to determine the impact of a change to the codebase (e.g., data processing, pipeline code changes). In this example, the changes to the codebase do not affect the input entering the CM 210. If the CM is deterministic, then the outputs 218 and 220 can be compared. More specifically, the output metric unit test may perform a soft comparison as changes to the dataset or output may be expected. In one example, only minor changes are expected. Thus, a threshold between the outputs 218 and 220 can be determined. In this example, the metadata 212 and 214 may include values output by the CM with respect to a given dataset or set of datasets thereof. If a soft comparison is performed, the unit test may be successful if the deviation or difference is within a threshold or is acceptable to a user.

The unit test 216 may be an evolution metric unit test. This type of unit test is configured to compare the evolution of a given metric across an interval of time or steps, such as the validation loss curve. The metadata may include values related to the evolution of one or more metrics across time, such as for training, validation, or the like.

The change 204 may include changes to the model pipeline, datasets, or codebase. For example, datasets used in machine models undergo processing. The change 204 may be related to data ETL (Extract-Transform-Load). This is a process of moving and transforming data from an environment where the data is stored to a volume where it can be used, such as by a machine learning model. This may include feature extraction, parameter related processing, or the like. Any modification to the ETL process (e.g., the change 204) may affect the behavior of the model 202. As a result, unit tests may be created to determine whether changes to the ETL in the context of the CMs have affected the behavior of the original model. Thus, the impact of the ETL changes on the model 202 can be determined based on the output 220 using the metadata 214 of the CM 210.

The change 204 may relate to library updates or rollbacks. When there is a modification to a library used to process or model a codebase (e.g., Machine Learning framework libraries), it is useful to test for the expected behavior of the model based on how these changes relate to how the model is trained, runs, or is stored.

The change 204 may relate to hardware changes. Modifications to the hardware (e.g., CPU (Central Processing Unit)/GPU (Graphical Processing Unit) version) running the model may impact the behavior of the model. It may be useful to ensure that these changes do not change or only minimally change (within a threshold) the expected behavior.

As previously suggested unit tests can be performed to ensure that expected behavior does not change or that the behaviors do not deviate from expected behavior by more than a threshold. Embodiments of the invention integrate model compression and unit testing in the same framework.

### B. Aspects of Testing VLMs for Data Drift

As discussed previously, the framework discussed above in relation to FIGS. 1 and 2 is able to test VLMs using the CMs. The framework may not account, however, for possible changes to the underlying distribution of the data used to train the VLM. That is-if a change in that distribution (i.e., data drift) exists in the domain, the ‘unit tests’ with the compressed models may fail in cases in which the VLM still retains total (or sufficient) functionality. This may signal or trigger unnecessary re-training of the VLM-which, again, is extremely expensive and cost-intensive.

The embodiments disclosed here provide for an extension and adaptation to the framework of FIGS. 1 and 2 to account for changes in the data distribution between the time at which the VLM and the compressed test model are trained and the time at which the test with the compressed model takes place. This helps to ensure that the training and validation behavior of these models remain close to an expected one. Since these models are very large, there is a prohibitive cost on retraining/revalidating them every time a change is made to codebase or data. The embodiments disclosed herein help to prevent this since those models whose training and validation behavior remain close to the expected behavior will not need to be retrained or revalidated.

The embodiments disclosed herein have two main phases: offline and online. The goal of the offline phase is to learn a model of how the VLM behaves under data distribution shifts in terms of its relevant metrics. The goal of the online phase is to detect false positives/negatives of VLM unit tests. That is, to know whether a unit test's failing or passing is related to the data having shifted or due to the actual test having passed or failed.

### B.1 Offline Phase

In the offline phase, a VLM is trained and tested, and relevant metrics are collected. Then, perturbation functions are applied to a test dataset to obtain variations of the dataset (i.e., shifted datasets) and to collect relevant metrics with the variations of the dataset. These perturbation test metrics are then correlated with the shifted datasets so that an estimation model for test metrics on unknown shifted datasets can be obtained.

### B.1.1 Training and Testing Stage

FA illustrates a training and testing stage 300 that in operation goes from an untrained VLM and a given dataset to a trained VLM. The training and testing stage 300 can then generate both training and testing metrics that are computed using a training dataset and a testing dataset. In one embodiment, the training and testing stage 300 is implemented using the framework discussed above in relation to FIGS. 1 and 2, although this is not required as in other embodiments differing frameworks may also be used. That is, the training and testing stage 300 is not tied to any particular training and testing regime.

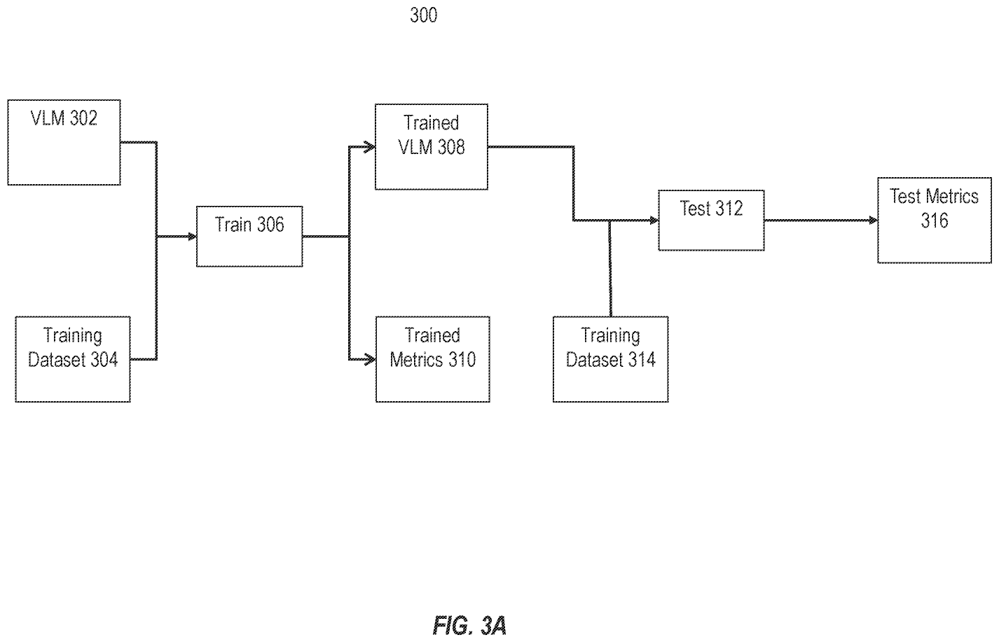

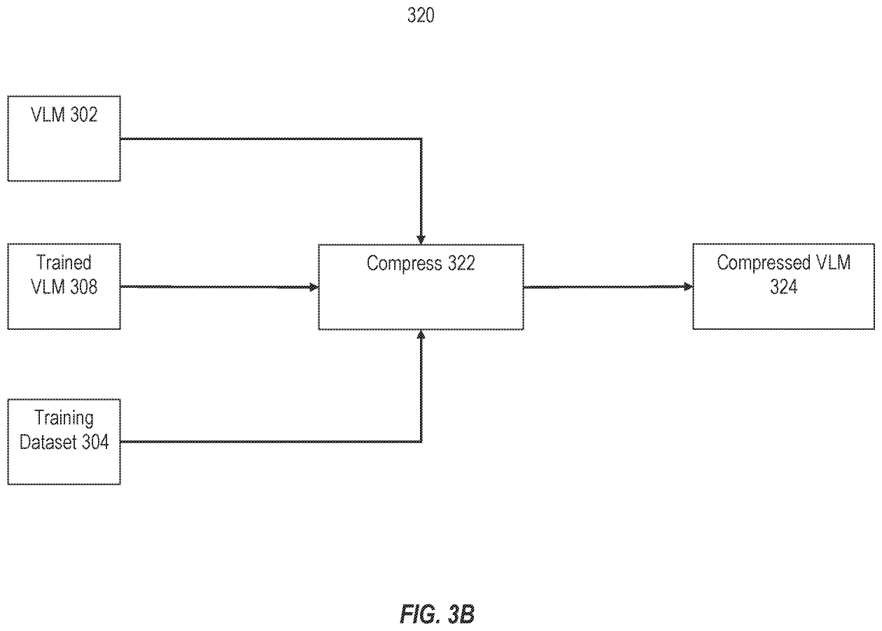

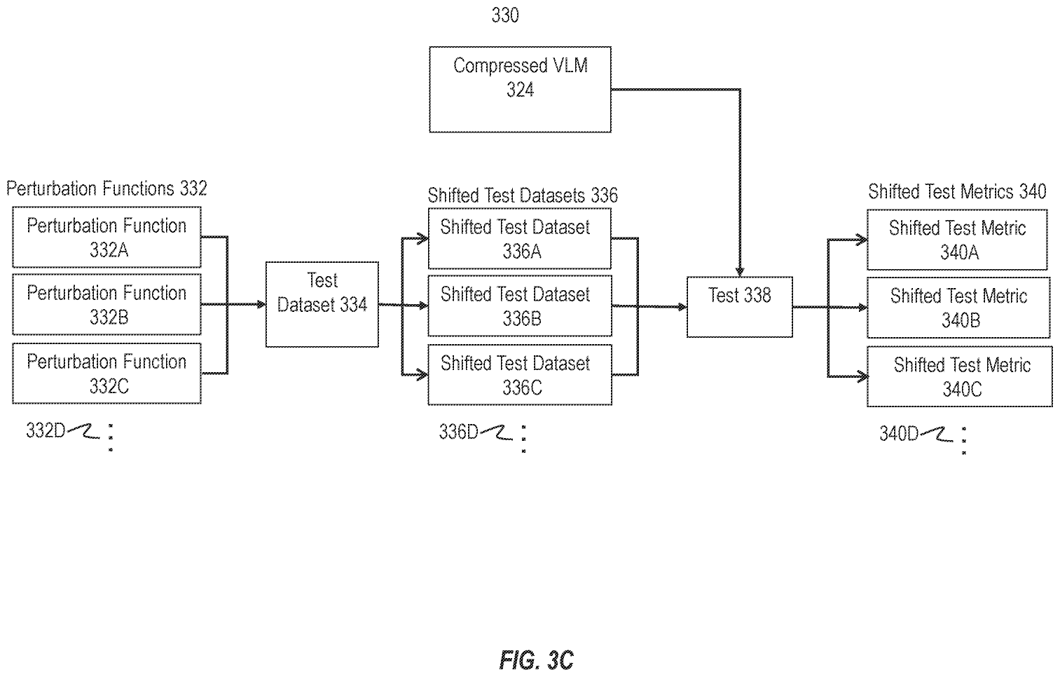

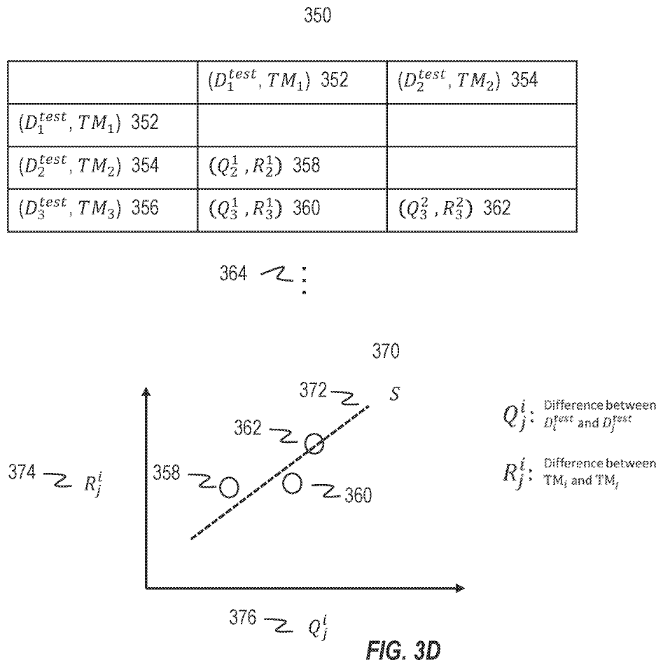

As illustrated, the training and testing stage 300 includes a VLM 302, which may correspond to the VLMs discussed in relation to FIGS. 1 and 2, and a training dataset 304. The VLM 302 is trained 306 using the training dataset 304. This results in a trained VLM 308, which may correspond to the trained VLMs discussed in relation to FIGS. 1 and 2, and training metrics or metadata 310, which may correspond to the metrics or metadata discussed in relation to FIGS. 1 and 2. The trained VLM 308 is then used to test 312 a test dataset 314. This results in test metrics 316, which correspond to the metrics or metadata discussed in relation to FIGS. 1 and 2. It will be appreciated that although the embodiment shown in FIG. 3A shows the training and testing stage 300 being used for one VLM and one training and testing dataset, the training and testing stage 300 may be used on multiple VLMS and datasets.

### B.1.2 Compression Stage

FIG. 3B illustrates a compression stage 320 that in operation goes from a VLM specification, a trained VLM, and a given dataset to a compressed version of the VLM that can serve as a proxy to the original VLM. In one embodiment, the compression stage 320 is implemented using the framework discussed above in relation to FIGS. 1 and 2, although this is not required as in other embodiments differing frameworks may also be used.

As illustrated, the compression stage 320 includes the VLM 302, the training dataset 304, and the trained VLM 308. The VLM 302 and/or the trained VLM 308 are compressed 322 using any compression method to generate a compressed VLM 324.

### B.1.3 Metric Correlation Stage

FIG. 3C illustrates a metric correlation stage 330 that in operation goes from a compressed VLM and a given dataset to test metrics computed on varied or shifted versions of the dataset and their correlations to shifting differences. As illustrated in FIG. 3, a set of perturbation functions ƒ (ƒᵢ for each function) 332 are applied to test dataset 334. The set of perturbation functions 332 are determined by the compressed VLM 324 being tested and are configured to shift the test dataset to obtain a shifted test dataset (Dᵢ^{test} for each shifted test dataset) 336. For example, suppose that the compressed VLM 324 was a model to test the response of a camera sensor. In such case, the set of perturbation functions 332 could remove some pixels so as to test if the sensor is faulty. Thus, the shifted test dataset 336 would include data that is shifted from the camera having the normal pixel count. In the illustrated embodiment, the set of perturbation functions 332 include a perturbation function ƒ₁ 332A, a perturbation function ƒ₂ 332B, a perturbation function ƒ₃ 332C, and any number of additional perturbation function ƒ₁ 332D as illustrated by the ellipses.

As mentioned, the set of perturbation functions 332 are applied to test dataset 334 to obtain the shifted test dataset 336. In the illustrated embodiment, the shifted test dataset 336 includes a shifted test dataset D₁^{test} 336A, a shifted test dataset D₂^{test} 336B, a shifted test dataset D₃^{test} 336C, and any number of additional shifted test datasets Dᵢ^{test} 336D as illustrated by the ellipses.

Each shifted dataset 336A-336D is then tested 338 by the compressed VLM 324 to obtain a set of shifted test metrics (TMᵢ for each test metric) 340. That is, each application of a perturbation function to the test dataset 334 will result in a different shifted test metric 340. In the illustrated embodiment, the shifted test metrics 340 includes a shifted test metric TM₁ 340A that is obtained by testing the shifted test dataset D₁^{test} 336A, a shifted test metric TM₂ 340B that is obtained by testing the shifted test dataset D₂^{test} 336B, a shifted test metric TM₃ 340C that is obtained by testing the shifted test dataset D₃^{test} 336C, and any number of additional shifted test metrics TMᵢ 340D as illustrated by the ellipses that are obtained by testing the additional shifted datasets Dᵢ^{test} 336D. Thus, each shifted test metric 340A-340D is associated with a shifted test dataset 336A-336D.

Having computed the set of shifted test metrics 340, two values per (D₁^{test}, TMᵢ) pair are computed that are: Qⱼⁱ, the difference between Dᵢ^{test} and Dⱼ^{test}; and Rⱼⁱ, the difference between TMᵢ and TMⱼ. In other words, an aggregate distance is computed between the two value pairs to output a single value. The aggregate distance can be computed using any reasonable function such as finding an average between the two value pairs.

FIG. 3D illustrates a correlation matrix 350 that shows the Qⱼⁱ and Rⱼⁱ values for each (Dᵢ^{test}, TMᵢ) pair. As shown, the correlation matrix 350 includes three (Dᵢ^{test}, TMᵢ) pairs: a (D₁^{test}, TM₁) pair 352, a (D₂^{test}, TM₂) pair 354, and a (D₃^{test}, TM₃) pair 356. The correlation matrix also shows the Qⱼⁱ and Rⱼⁱ values for the differences between the (Dᵢ^{test}, TMᵢ) pairs 352, 354, and 356. As shown at 358, the Qⱼⁱ and Rⱼⁱ values for the difference between the (Dᵢ^{test}, TMᵢ) pairs 352 and 354 is (Q₂¹, R₂¹), the Qⱼⁱ and Rⱼⁱ values for the difference between the (Dᵢ^{test}, TMᵢ) pairs 352 and 356 is (Q₃¹, R₃¹), and the Qⱼⁱ and Rⱼⁱ values for the difference between the (Dᵢ^{test}, TMᵢ) pairs 354 and 356 is (Q₃², R₃²). The ellipses 364 represent that the correlation matrix 350 may include additional (Dᵢ^{test}, TMᵢ) pairs with their corresponding Qⱼⁱ and Rⱼⁱ values if there are more than three shifted test datasets and shifted test metrics.

The (Qⱼⁱ, Rⱼⁱ) pairs can then be used to build a correlation model S. The correlation model S model in operation allows for an estimation of what is the expected difference in the test metric R given the difference in data distribution as will be explained in more detail to follow. That is, the correlation model S estimates the difference between the test metrics given the distance between datasets.

FIG. 3D illustrates a graphical representation 370 of a correlation model S 372 that is built using the (Qⱼⁱ, Rⱼⁱ) pairs 358, 360, and 362. As illustrated, the graphical representation 370 includes Qⱼⁱ 376 as a horizontal axis and Rⱼⁱ 374 as a vertical axis. The (Qⱼⁱ, Rⱼⁱ) pairs 358, 360, and 362 shown in the graphical representation 370 show a graphical representation of the difference between each pairs Qⱼⁱ value and each pairs Rⱼⁱ values that are used to build the correlation model S 372.

### B.2 Online Phase

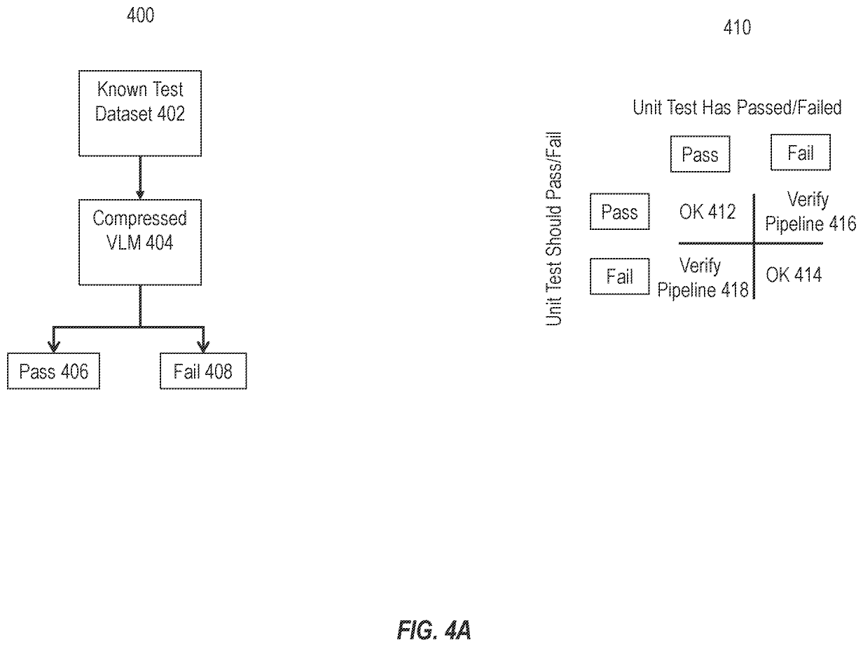

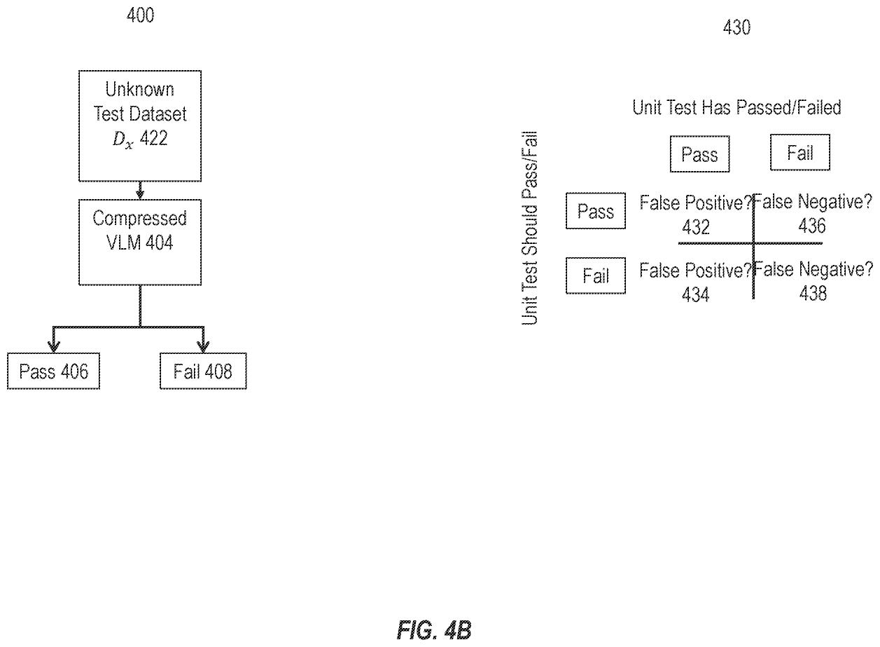

FIG. 4A illustrates an example of a unit test 400 when a dataset is known. As illustrated a known dataset 402 is tested by a compressed VLM 404, which may correspond to the any of the VLMs previously discussed. The result will be either that the unit test 400 passed 406 or failed 408.

FIG. 4A also illustrates a confusion matrix 410 for the results of the unit test 400 when testing the known dataset 402. As shown at 412, the unit test was expected to pass and it did pass and as shown at 414, the unit test was expected to fail, and it did fail. Since in both cases the results of the unit test were as expected, the results can be trusted, and no retraining or revalidation of the data pipeline is needed.

As shown at 416, the unit test was expected to pass, but it failed and as shown at 418, the unit test was expected to fail, but it passed. Since the dataset is a known dataset, a user will know not to trust these results and therefore can perform retraining or revalidation of the data pipeline as needed.

FIG. 4B illustrates an example of the unit test 400 when a dataset is unknown. As illustrated an unknown dataset Dₓ 422 is tested by the compressed VLM 404. The result will be either that the unit test 400 passed 406 or failed 408.

FIG. 4B also illustrates a confusion matrix 430 for the results of the unit test 400 when testing the unknown dataset Dₓ 422. As shown at 432, the unit test is shown as passing when it was expected to pass, but because the dataset Dₓ 422 is unknown, it is not known if this is a false positive or not. As shown at 434, the unit test is shown as passing when it was expected to fail, but because the dataset Dₓ 422 is unknown, it is not known if this is a false positive or not. As shown at 436 the unit test is shown as failing when it was expected to pass, but because the dataset Dₓ 422 is unknown, it is not known if this is a false negative or not. As shown at 438, the unit test is shown as failing when it was expected to fail, but because the dataset Dₓ 422 is unknown, it is not known if this is a false negative or not. Since the dataset is an unknown dataset, a user will not know if the results should be trusted and may therefore have to perform retraining or revalidation on the data pipeline before the results can be trusted. However, if the results were not false positives or false negatives, but were in fact true positives or true negatives, then the user may have gone through the costly retraining or revalidation process for no reason.

The embodiments disclosed herein provide for an online phase where checks of the unit tests for the VLM can then be made against the unknown dataset Dₓ using test metrics and the correlation model S generated during an offline phase. The idea is that, if the distribution shift of the unknown dataset Dₓ in relation to the datasets on which the VLM was tested (e.g., shifted test datasets 336) is small enough, both the passing and failing of a unit test can be trusted as likely being valid. In such a case, the unit test's failing or passing is likely related to the data having shifted and no retraining or revalidation of the data pipeline is needed.

If, however, the distribution shift of the unknown dataset Dₓ in relation to the datasets on which the VLM was tested is large enough, it is possible that if the results show a test passing, this is a false positive, or if the results show a test failing, this is a false negative. Thus, a user may be uncertain if the unit test's failing or passing is due to the actual test having passed or failed or due to the false positive/negative. In such cases, retraining or revalidation of the data pipeline may be needed to determine the cause of the unit test's failing or passing. However, any such retraining or revalidation will be less than the case of FIG. 4B since any changes due to the data having shifted need not lead to retraining or revalidation.

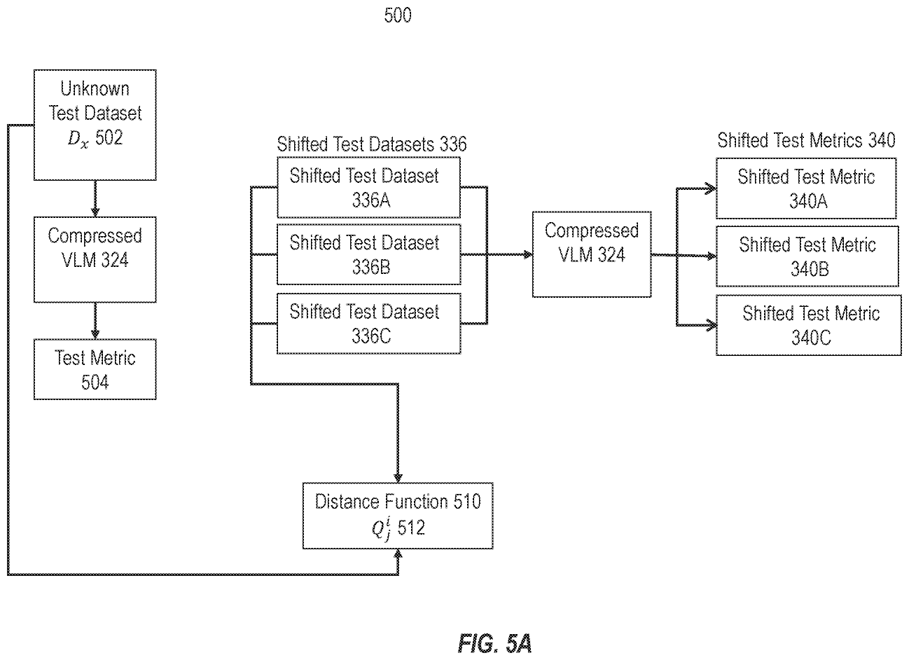

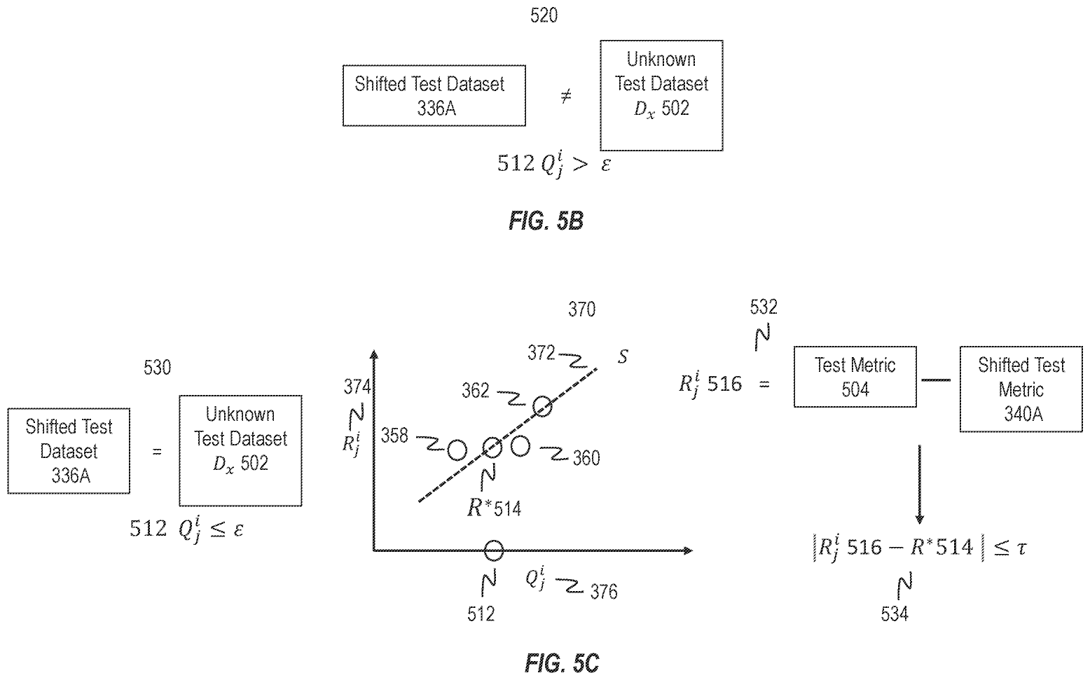

FIG. 5A illustrates an offline phase 500. FIG. 5A shows the shifted test datasets 336 that are tested by the compressed VLM 324 to obtain the shifted test metrics 340 as previously described in relation to FIG. 3C. FIG. 5A also shows an unknown dataset Dₓ 502 that is tested by the compressed VLM 324 to obtain a test metric 504.

The unknown dataset Dₓ 502 and the shifted test datasets 336A, 336B, and 336C are applied to a distance function 510 to determine a distribution distance quantity or value Qᵢ^{j} between the unknown dataset Dₓ 502 and each of the shifted test datasets 336A, 336B, and 336C. The distance function 510 then determines which distribution distance between the unknown dataset Dₓ 502 and each of the shifted test datasets 336A, 336B, and 336C is the shortest, or in other words which one of the shifted test datasets 336 is closest to the unknown dataset Dₓ 502 based on having the shortest or smallest distribution distance Qᵢ^{j} 512 with the unknown dataset Dₓ 502. In some embodiments the distance function 510 may be a histogram of label distributions for a classification task or the continuous distribution for a regression task. Then, it would be possible to calculate a probability distribution divergence as the distance between the two datasets.

FIG. 5B illustrates an embodiment 520 where the shifted test dataset 336A is found to be closest to the unknown dataset Dₓ 502 so that the distribution distance Qᵢ^{j} 512 is the distance between these two datasets. Once the distribution distance Qᵢ^{j} 512 is calculated, the distribution is checked against a first known threshold E, which in one embodiment is based on an average of all the distribution distances between the unknown dataset Dₓ 502 and each of the shifted test datasets 336A, 336B, and 336C. If the distribution distance Qᵢ^{j} 512 is larger than the first known threshold E, as is the case in the embodiment 520, then this shows that the unknown dataset Dₓ 502 is quite different from the shifted test dataset 336A, which is the closest dataset, since the distribution distance is large. Thus, the results are likely to be false positives or false negatives and retraining or revalidation of the data pipeline is likely needed to verify if the unit tests are correct.

FIG. 5C shows an embodiment 530 where the shifted test dataset 336A is also found to be closest to the unknown dataset Dₓ 502 so that the distribution distance Qᵢ^{j} 512 is the distance between these two datasets. In the embodiment 530, however, the distribution distance Qᵢ^{j} 512 is found to be less than or equal to the first known threshold E, thus showing that the unknown dataset Dₓ 502 is close or similar to the shifted test dataset 336A since the distribution distance is small. Accordingly, a further test is done to determine if the unit test results are trustworthy.

As shown in FIG. 5C, the distribution distance Qᵢ^{j} 512 is applied to the correlation model S 372 that was built during the offline stage and an estimated test metric difference R* is calculated. This may be seen on the graphical representation 370 of the correlation model S 372 where the value of Q 512 is plotted and then used to determine an estimated test metric difference R* 514.

As part of the further test, the test metric difference Rᵢ^{j} 516 between the test metric 504 obtained from the unknown dataset Dₓ 502 and the shifted test metric 340A obtained from the shifted test dataset 336A is calculated as shown in FIG. 5C at 532 as: test metric 504—shifted test metric 340A. A difference between the estimated test metric difference R* 514 and the metric difference Rᵢ^{j} 516 is then checked against a second known threshold τ. In one embodiment, the second known threshold τ is based on an average of differences between shifted test metrics 340A-340C.

For example, as shown in FIG. 5C at 534, the difference between the estimated test metric difference R* 514 and the metric difference Rᵢ^{j} 516 is checked against the second known threshold as follows: |Rᵢ^{j} 516−R* 514|≤τ. If the difference is low (less or equal to the second known threshold τ), then the unit tests can be considered trustworthy and there will be no need for retraining or revalidation of the data pipeline. In some embodiments, a warning flag representing the discrepancy may be generated. However, if the difference is high (above the second known threshold i), then the unit tests are not to be trustworthy and retraining or revalidation of the data pipeline is likely needed to verify if the unit tests are correct.

### C. Example Methods

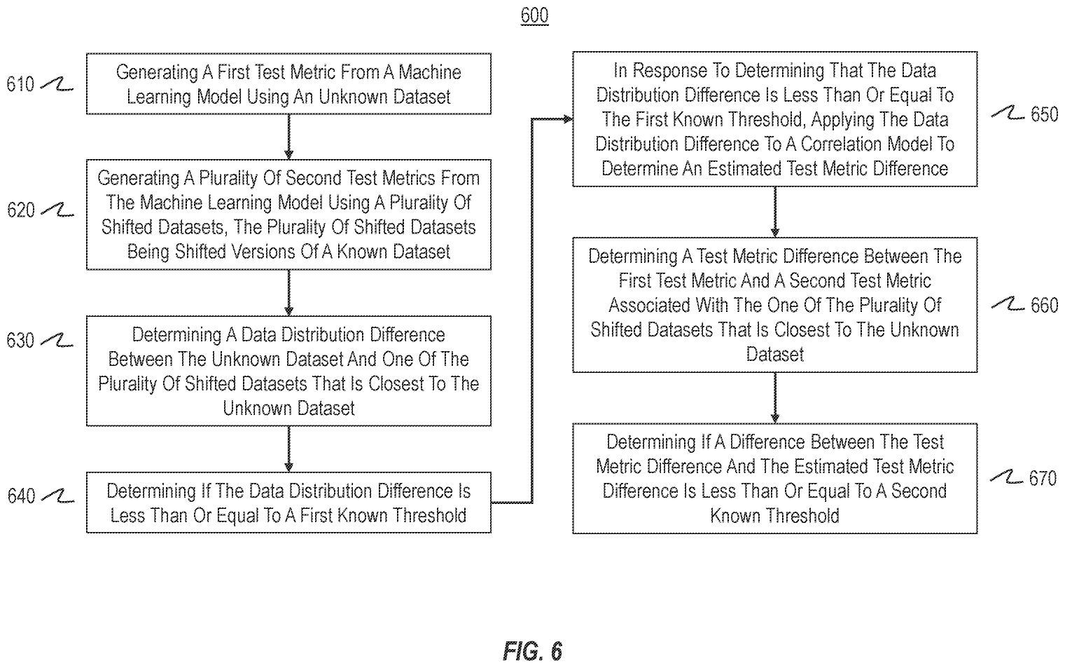

It is noted with respect to the disclosed methods, including the example method of FIG. 6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 6, an example method 600 is disclosed. The method 600 will be described in relation to one or more of the figures previously described, although the method 600 is not limited to any particular embodiment.

The method 600 includes generating a first test metric from a machine learning model using an unknown dataset (610). For example, as previously the test metric 504 is generated from the compressed VLM 324 using the unknown dataset Dₓ 502.

The method 600 includes generating a plurality of second test metrics from the machine learning model using a plurality of shifted datasets, the plurality of shifted datasets being shifted versions of a known dataset (620). For example, as previously described the shifted test metrics 340A-340D are generated using the compressed VLM 324 using the shifted test datasets 336A-336D. The shifted test datasets 336A-336D are shifted from the test dataset 334 based on the application of the perturbation functions 332A-332D.

The method 600 includes determining a data distribution difference between the unknown dataset and one of the plurality of shifted datasets that is closest to the unknown dataset (630). For example, as previously described distance function 510 determines the distribution distance Qᵢ^{j} 512 between the unknown dataset Dₓ 502 and the shifted test dataset 336A. In some embodiments, this done by finding all the distribution differences between the unknown dataset Dₓ 502 and the shifted test datasets 336A-336D and then finding the test dataset having the shortest distance to the unknown dataset Dₓ 502.

The method 600 includes determining if the data distribution difference is less than or equal to a first known threshold (640). For example, as previously described the distribution distance Qᵢ^{j} 512 is checked to see if it is less than or equal to the first known threshold E.

The method 600 includes in response to determining that the data distribution difference is less than or equal to the first known threshold, applying the data distribution difference to a correlation model to determine an estimated test metric difference (650). For example, as previously described when the distribution distance Qᵢ^{j} 512 is less than or equal to the first known threshold E, the distribution distance Qᵢ^{j} 512 can be applied to the correlation model S 372 to determine the estimated test metric difference R* 514.

The method 600 includes determining a test metric difference between the first test metric and a second test metric associated with the one of the plurality of shifted datasets that is closest to the unknown dataset (660). For example, as previously described the test metric difference Rᵢ^{j} 516 between the test metric 504 obtained from the unknown dataset Dₓ 502 and the shifted test metric 340A is determined.

The method 600 includes determining if a difference between the test metric difference and the estimated test metric difference is less than or equal to a second known threshold (670). For example, as previously described the difference between the estimated test metric difference R* 514 and the metric difference Rᵢ^{j} 516 is checked against the second known threshold as follows: |Rᵢ^{j} 516−R* 514|≤τ. If the difference is low (less or equal to the second known threshold τ), then the unit tests can be considered trustworthy and there will be no need for retraining or revalidation of the data pipeline. However, if the difference is high (above the second known threshold τ), then the unit tests are not to be trustworthy and retraining or revalidation of the data pipeline is likely needed to verify if the unit tests are correct.

### D. Further Example Embodiments

Following are some further example embodiments of the invention. These are presented only by way of example and are not intended to limit the scope of the invention in any way.

Embodiment 1. A method, comprising: generating a first test metric from a machine learning model using an unknown dataset; generating a plurality of second test metrics from the machine learning model using a plurality of shifted datasets, the plurality of shifted datasets being shifted versions of a known dataset; determining a data distribution difference between the unknown dataset and one of the plurality of shifted datasets that is closest to the unknown dataset; determining if the data distribution difference is less than or equal to a first known threshold; in response to determining that the data distribution difference is less than or equal to the first known threshold, applying the data distribution difference to a correlation model to determine an estimated test metric difference; determining a test metric difference between the first test metric and a second test metric associated with the one of the plurality of shifted datasets that is closest to the unknown dataset; and determining if a difference between the test metric difference and the estimated test metric difference is less than or equal to a second known threshold.

Embodiment 2. The method as recited in embodiment 1, wherein determining that the data distribution difference is greater than the first known threshold is indicative of a false positive or false negative and that retraining, or revalidation of the machine learning model is to be performed.

Embodiment 3. The method as recited in any of embodiments 1-2, wherein determining that the difference between the test metric difference and the estimated test metric difference is greater than the second known threshold is indicative of a false positive or false negative and that retraining, or revalidation of the machine learning model is to be performed.

Embodiment 4. The method as recited in any of embodiments 1-3, wherein determining that the difference between the test metric difference and the estimated test metric difference is less than or equal to a second known threshold is indicative that an underlying data pipeline of the machine learning model is operating in an expected manner.

Embodiment 5. The method as recited in any of embodiments 1-4, wherein determining a data distribution difference between the unknown dataset and one of the plurality of shifted datasets that is closest to the unknown dataset comprises: determining a data distribution difference between the unknown dataset and each of the plurality of shifted datasets; and selecting the one of the plurality of shifted datasets that is closest to the unknown dataset based on the one of the plurality of shifted datasets having a smallest data distribution difference with the unknown dataset.

Embodiment 6. The method as recited in any of embodiments 1-5, further comprising: generating a plurality of second data distributions between each of the plurality of shifted datasets; generating a plurality of second test metric differences between each of the second test metrics; and generating the correlation model based on the plurality of second data distributions and the plurality of second test metric differences.

Embodiment 7. The method as recited in any of embodiments 1-6, wherein the machine learning model is a compressed Very Large Model (VLM) that acts as a proxy for a VLM.

Embodiment 8. The method as recited in any of embodiments 1-7, further comprising: applying a plurality of perturbation functions to the known dataset to generate the plurality of shifted datasets

Embodiment 9. The method as recited in any of embodiments 1-8, wherein the first known threshold is based on an average of a data distribution difference between the unknown dataset and each of the plurality of shifted datasets.

Embodiment 10. The method as recited in any of embodiments 1-9, wherein the second known threshold is based on an average of second test metric differences between each of the second test metrics.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

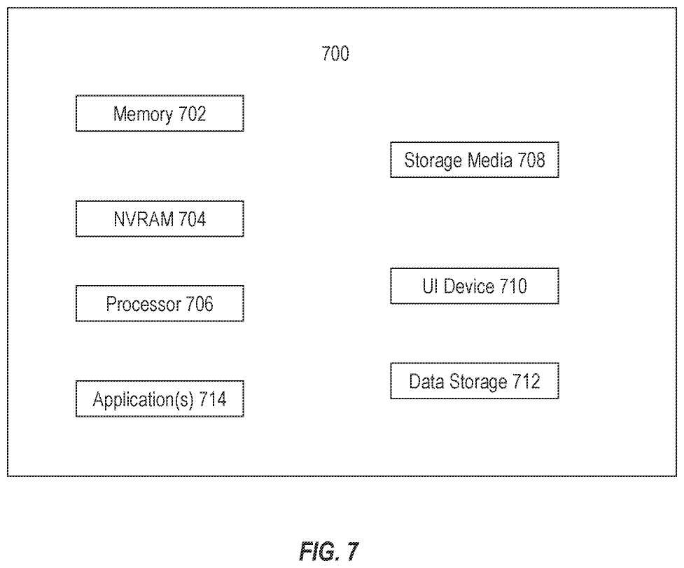

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
generating a first test metric from a machine learning model using an unknown dataset;
generating a plurality of second test metrics from the machine learning model using a plurality of shifted datasets, the plurality of shifted datasets being shifted versions of a known dataset;
determining a data distribution difference between the unknown dataset and one of the plurality of shifted datasets that is closest to the unknown dataset;
determining if the data distribution difference is less than or equal to a first known threshold;
in response to determining that the data distribution difference is less than or equal to the first known threshold, applying the data distribution difference to a correlation model to determine an estimated test metric difference;
determining a test metric difference between the first test metric and a second test metric associated with the one of the plurality of shifted datasets that is closest to the unknown dataset; and
determining if a difference between the test metric difference and the estimated test metric difference is less than or equal to a second known threshold.

2. The method of claim 1, wherein determining that the data distribution difference is greater than the first known threshold is indicative of a false positive or false negative and that retraining, or revalidation of the machine learning model is to be performed.

3. The method of claim 1, wherein determining that the difference between the test metric difference and the estimated test metric difference is greater than the second known threshold is indicative of a false positive or false negative and that retraining, or revalidation of the machine learning model is to be performed.

4. The method of claim 1, wherein determining that the difference between the test metric difference and the estimated test metric difference is less than or equal to a second known threshold is indicative that an underlying data pipeline of the machine learning model is operating in an expected manner.

5. The method of claim 1, wherein determining a data distribution difference between the unknown dataset and one of the plurality of shifted datasets that is closest to the unknown dataset comprises:
determining a data distribution difference between the unknown dataset and each of the plurality of shifted datasets; and
selecting the one of the plurality of shifted datasets that is closest to the unknown dataset based on the one of the plurality of shifted datasets having a smallest data distribution difference with the unknown dataset.

6. The method of claim 1, further comprising:
generating a plurality of second data distributions between each of the plurality of shifted datasets;
generating a plurality of second test metric differences between each of the second test metrics; and
generating the correlation model based on the plurality of second data distributions and the plurality of second test metric differences.

7. The method of claim 1, wherein the machine learning model is a compressed model that acts as a proxy for another machine learning model.

8. The method of claim 1, further comprising:
applying a plurality of perturbation functions to the known dataset to generate the plurality of shifted datasets.

9. The method of claim 1, wherein the first known threshold is based on an average of a data distribution difference between the unknown dataset and each of the plurality of shifted datasets.

10. The method of claim 1, wherein the second known threshold is based on an average of second test metric differences between each of the second test metrics.

11. A non-transitory storage medium having stored therein instructions that are executable by one or more hardware processors to perform operations comprising:
generating a first test metric from a machine learning model using an unknown dataset;
generating a plurality of second test metrics from the machine learning model using a plurality of shifted datasets, the plurality of shifted datasets being shifted versions of a known dataset;
determining a data distribution difference between the unknown dataset and one of the plurality of shifted datasets that is closest to the unknown dataset;
determining if the data distribution difference is less than or equal to a first known threshold;
in response to determining that the data distribution difference is less than or equal to the first known threshold, applying the data distribution difference to a correlation model to determine an estimated test metric difference;
determining a test metric difference between the first test metric and a second test metric associated with the one of the plurality of shifted datasets that is closest to the unknown dataset; and
determining if a difference between the test metric difference and the estimated test metric difference is less than or equal to a second known threshold.

12. The non-transitory storage medium of claim 11, wherein determining that the data distribution difference is greater than the first known threshold is indicative of a false positive or false negative and that retraining, or revalidation of the machine learning model is to be performed.

13. The non-transitory storage medium of claim 11, wherein determining that the difference between the test metric difference and the estimated test metric difference is greater than the second known threshold is indicative of a false positive or false negative and that retraining, or revalidation of the machine learning model is to be performed.

14. The non-transitory storage medium of claim 11, wherein determining that the difference between the test metric difference and the estimated test metric difference is less than or equal to a second known threshold is indicative that an underlying data pipeline of the machine learning model is operating in an expected manner.

15. The non-transitory storage medium of claim 11, wherein determining a data distribution difference between the unknown dataset and one of the plurality of shifted datasets that is closest to the unknown dataset comprises:
determining a data distribution difference between the unknown dataset and each of the plurality of shifted datasets; and
selecting the one of the plurality of shifted datasets that is closest to the unknown dataset based on the one of the plurality of shifted datasets having a smallest data distribution difference with the unknown dataset.

16. The non-transitory storage medium of claim 11, further comprising:
generating a plurality of second data distributions between each of the plurality of shifted datasets;
generating a plurality of second test metric differences between each of the second test metrics; and
generating the correlation model based on the plurality of second data distributions and the plurality of second test metric differences.

17. The non-transitory storage medium of claim 11, wherein the machine learning model is a compressed model that acts as a proxy for another machine learning model.

18. The non-transitory storage medium of claim 11, further comprising:
applying a plurality of perturbation functions to the known dataset to generate the plurality of shifted datasets.

19. The non-transitory storage medium of claim 11, wherein the first known threshold is based on an average of a data distribution difference between the unknown dataset and each of the plurality of shifted datasets.

20. The non-transitory storage medium of claim 11, wherein the second known threshold is based on an average of second test metric differences between each of the second test metrics.
